(19) United States
(12) Patent Application Publication
(10) Pub. No.: US 2016/0353670 A1
(43) Pub. Date: Dec. 8, 2016

(54) Flower Arrangement Jig

(71) Applicant: Lioz AGABABA, Petah Tikvah (IL)

(72) Inventor: Lioz AGABABA, Petah Tikvah (IL)

(21) Appl. No.: 15/107,109

(22) PCT Filed: Dec. 23, 2014
(86) PCT No.: PCT/IB14/67276

§ 371 Date: Jun. 22, 2016

Related U.S. Application Data
(60) Provisional application No. 61/920,600, filed on Dec. 24, 2013.

(51) Int. Cl. A01G 5/02; A47G 7/02; A01G 5/04

(52) U.S. Cl. CPC A01G 5/02; A01G 5/04; A47G 7/02

(57) ABSTRACT

The present invention provides an easier and faster way to arrange a bouquet of flowers. According to some embodiments, a jig has multiple tubes skew to each other with rods inserted therein. With the rods extending out of one end of the tubes, flower/foliage elements are inserted into the other ends of the tubes to form a bouquet. Then, the stems of the flower/foliage elements are grasped while the tubes are moved further from the grasped portions of the stems causing the top faces of the rods to press the stems out of the tubes. Accordingly, the jig conveniently and snugly holds flower/foliage elements while forming the bouquet, and the rods effectively eject the flower/foliage elements from the jig when the bouquet is ready to be bound at the stems.

### RELATED APPLICATION

This application claims benefit under 35 U.S.C. §119(e) of the Dec. 24, 2013 filing of U.S. Provisional Application No. 61/920,600, which is hereby incorporated by reference in its entirety.

### BACKGROUND

Arranging a decorative bouquet of flowers is not as easy as simply grasping a set of flowers and filler foliage (e.g., green leaves) and tying the bundle together at the stems. According to one known method used in the field to arrange flowers, a florist begins by grasping the first flower, then grasping a second flower or foliage element in such a way as to orient its stem at approximately a 45 degree angle to the first flower's stem, rotating the pair in his/her hand to allow for third flower/foliage element to be added with its stem forming approximately a 45 degree angle with a stem already in the bundle, and repeating the rotate and add flower/foliage element steps multiple times. The bundle is then tied together.

This process of arranging a flower bouquet is time-consuming. Although florists can work faster with experience, proper attention must still be given at each step of the process to ensure that resulting bouquet is not only beautiful but has a relatively stable nature, that is, the relative positioning and angles of the individual flowers would not change if grasped in an unusual way. Thus, even the experience florist must carefully arrange and grip the bouquet elements throughout the arrangement procedure.

The present inventor is aware of no simple tool to increase the speed of arranging a bouquet that can reduce labor costs and also the training time required for new florists to become competent in this discipline.

### SUMMARY

Embodiments of the present invention provide an easier and faster way to arrange a bouquet. With minimal training, more people can become proficient at arranging bouquets. Also, a user temporarily interrupted from arranging a bouquet can more easily resume the task after the interrupting activity has concluded.

The invention may be embodied as a jig for arranging flowers. The jig has a set of multiple tubes, and each of the multiple tubes is oriented skew to the other tubes. A jig assembly for arranging flowers may be formed from this jig and multiple rods having diameters less than the inner diameters of the tubes of the jig.

The invention may also be embodied as a process of using a jig assembly to arrange a bouquet. The jig assembly includes multiple tubes oriented skew to each other and multiple rods inserted into the tubes. The process includes: positioning the tubes at a height so that the rods extend out of the tubes far enough to allow insertion of flower/foliage elements deep enough into the tubes to remain in place; inserting flower/foliage elements into the tubes; and grasping the stems of the flower/foliage elements while increasing the distance between the grasped portions of the stems and the tubes such that the force of the top faces of the rods against the bottoms of the stems increases. The distance is increased enough to remove the flower/foliage elements entirely from the jig.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIGS. 1-3 top, side, and perspective views, respectively, of an embodiment for arranging a bouquet;

FIGS. 4A-4E illustrate steps of an embodiment of a process of using the jig assembly of FIGS. 1-3 to arrange a bouquet;

FIGS. 5A and 5B illustrate a jig assembly of an alternate embodiment of the invention; and

FIG. 6 provides a flowchart indicating the process flow during the execution of a method of using a jig assembly to arrange a bouquet in accordance with another embodiment of the invention.

### DETAILED DESCRIPTION

The invention summarized above and defined by the claims below will be better understood by referring to the present detailed description of embodiments of the invention. This description is not intended to limit the scope of claims but instead to provide examples of the invention.

Described herein are embodiments of a jig that aids florists in arranging bouquets. With the jig, the individual flowers and filler foliage elements are constrained at the proper relative spatial positions and angles while freeing the florist's hands for associated or unrelated tasks. An example of an associated task is leaving the site of the jig to obtain a different flower to substitute with a flower already in the jig, should the florist decide a different flower would provide an appearance more appropriate to a given situation. An example of an unrelated task would be responding to a telephone call or to a customer entering the site, situations in which a florist would need to release his/her grasp of a partially-completed bouquet while attending to the unrelated task.

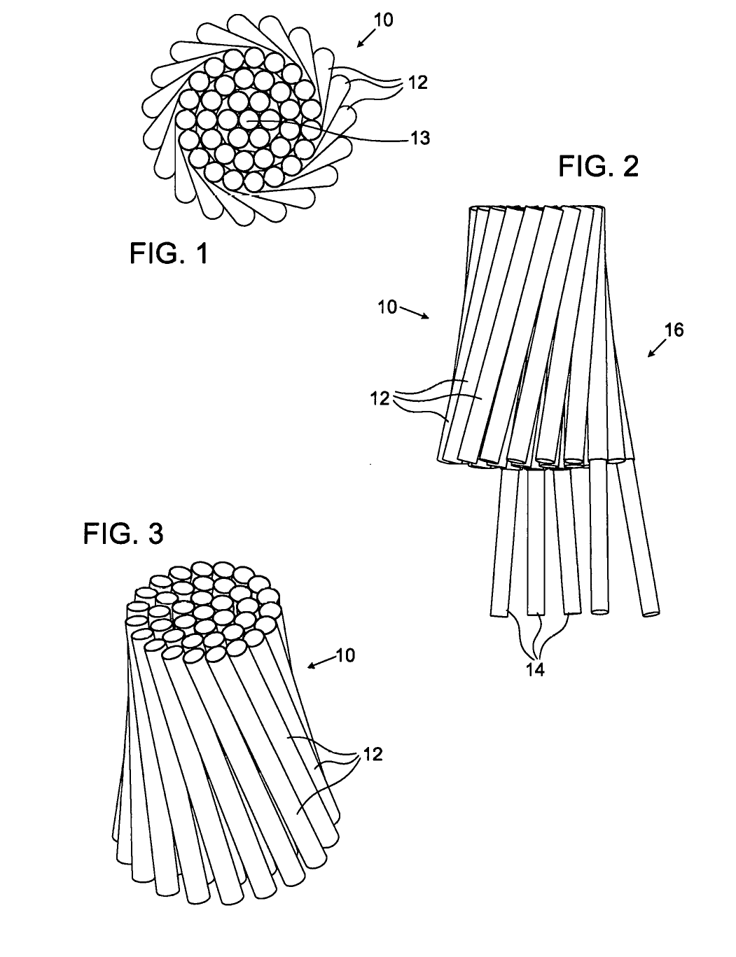

Reference is now made to FIGS. 1-3, which provide top, side, and perspective views, respectively, of one embodiment of jig 10 for arranging a bouquet of flowers. The jig 10 comprises multiple tubes 12 of approximately the same length, each tube 12 held in place skew to each other and at an angle to a common vertical, the common vertical defining an axis of radial symmetry of the arrangement of tubes 12. In some implementations, each tube 12 is oriented at roughly the same angle to a common vertical. Also in this embodiment is an additional tube 13 that is collinear with the common vertical and skew to each of the set of multiple tubes 12. The diameter of the tubes 12 is selected to be large enough to enable easy insertion and withdrawal of the individual stems of the intended flowers and foliage but small enough to constrain the flowers and foliage in place well enough to allow the user (for example, a florist) to release the stem of the individual flower/foliage from his/her grip. Generally, there is one tube 12 for each flower/foliage element 26 that a user would want in a finished bouquet.

The tubes 12 may be of many different materials, such as PVC or plastic, as non-limiting examples. They may be held together by epoxy, glue, or other means known in the art. The process of making the jig 10 may be as simple as taking two tubes 12, joining them with epoxy at the appropriate relative angle, then joining a third tube 12 to the pair with epoxy at the appropriate relative angle, and so on until the jig 10 is complete. Alternatively, all tubes 12 may be constrained in place (perhaps by a specially-made second jig) and then fastened to each other by appropriately-positioned beads or lines of epoxy. Other forms of manufacturing the jig 10 are within the scope of the invention.

In the present embodiment, rods 14 (a subset of the rods 14 shown in FIG. 2 for clarity) are inserted into the tubes 12. The rods 14 have diameters that are slightly less than the inner diameters of the tubes 12. The combination of the jig 10 and the rods 14 may be denoted as a “jig assembly,” as labeled “16” in FIG. 2. The length of the rods 14 of the jig assembly 16 may be selected to equal approximately the length of the tubes 12. The rods 14 may be made of wood, plastic, or metal, as non-limiting examples.

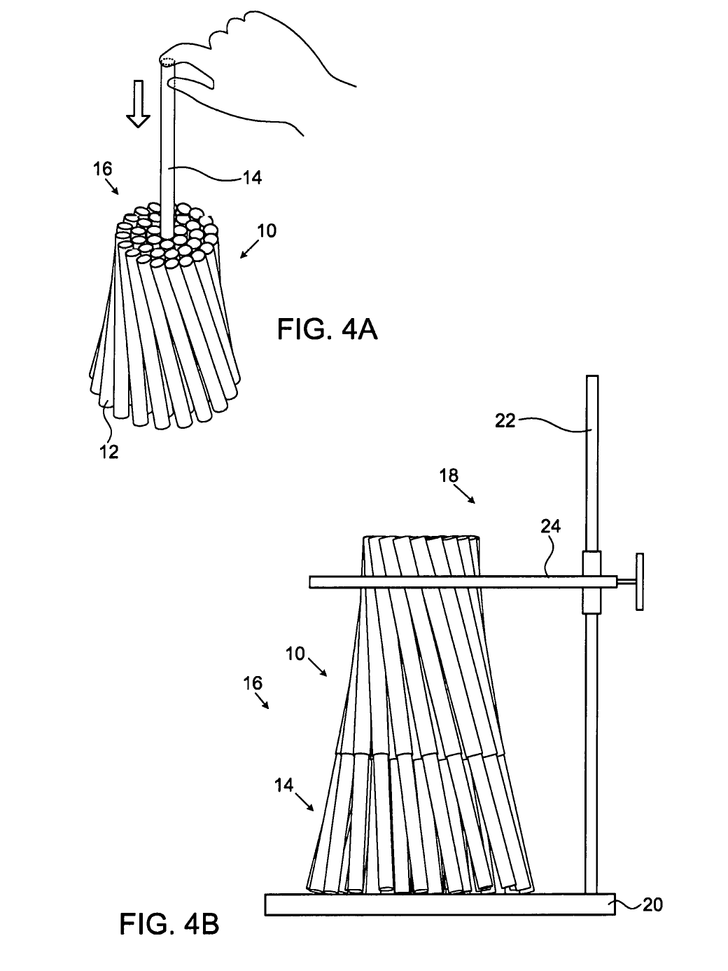

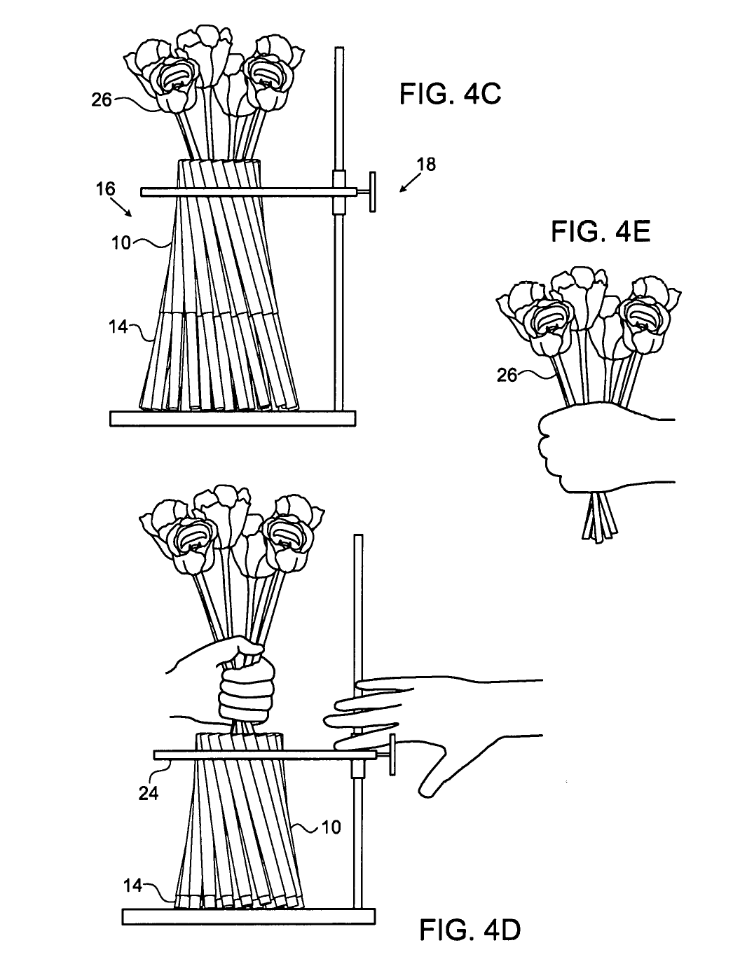

An embodiment of a process of using the jig assembly 16 to arrange a bouquet is described with reference to FIGS. 4A-4E. The jig assembly 16 in this embodiment includes a jig stand 18, which is illustrated in FIGS. 4B-4D and described in more detail below.

FIG. 4A illustrates a user inserting a rod 14 into one of the tubes 12. (The jig stand 18 is not illustrated in this figure for clarity.) The user continues inserting rods 14 into tubes 12 until each tube 12 has a rod 14 inserted therein. In alternate embodiments, though, a user may choose to insert rods 14 into only a subset of the tubes 12, if he/she wants to form a bouquet with fewer flowers and/or foliage elements 26 than one element 26 for each tube 12. In yet other embodiments, the user may choose to omit this step and to arrange a bouquet without using the rods 14.

FIG. 4B illustrates the jig 10 with each tube 12 having a rod 14 inserted therein and the jig 10 held in place by the jig stand 18. The jig stand 18 includes a base 20, a post 22 extending vertically upward from the base 20, and a sliding jig clamp 24 extending horizontally from the post 22 and holding the jig 10 as shown. Alternate constructions of jig stands may be used as would be deemed suitable or desired by one skilled in the art (one example shown below). With sufficient friction between the tubes 12 and the rod 14, the jig stand 18 may be omitted in other embodiments of the invention.

The sliding jig clamp 24 is adjusted to a height so that the rods 14 extend out from the bottoms of the tubes 12 far enough to allow insertion from the top of flower/foliage elements 26 deep enough into the tubes 12 so that the flower/foliage elements 26 remain in place (discussed in more detail next).

The user then inserts flower/foliage elements 26 into the tubes 12, each tube 12 holding one such element 26 in the present embodiment. FIG. 4C illustrates several flowers 26 already in place.

Unlike in the prior art, the user does not need to constantly grasp multiple flower/foliage elements 26 throughout the entire assembly process. He/She may leave the assembly site to attend to an associated or unrelated task and then later return to complete the assembly from the point where he/she previously stopped. The user can also easily change individual flower/foliage elements 26 as desired.

When the flowers and foliage elements 26 of the bouquet are arranged as desired, the user grasps the stems as illustrated in FIG. 4D (only a few flowers are illustrated for clarity) and lowers the sliding jig clamp 24 to lower the jig 10 and thereby enable removal of the bouquet. The user may gently pull the bouquet upward at the same time. (In FIG. 4D, the user has moved his hand to re-grip the bouquet at a lower position to be close to the top of the jig 10. Such step is optional.) For bouquets with only a few flower/foliage elements 26, the bouquet might be easily removable by simply lifting the individual elements 26 out of the tubes 12 without simultaneously lowering the jig 10. However, each flower/foliage element 26 exerts a frictional force against the associated tube interior when bouquet removal from the jig 10 is attempted in this fashion, so simply pulling the bouquet from the jig 10 becomes much more difficult when the bouquet contains many flowers and/or foliage elements 26. Accordingly, bouquet removal is facilitated by the top faces of the rods 14 pressing against the bottoms of the stems of the flowers/foliage elements 26 as the jig 10 is forced downward.

FIG. 4E illustrates the user grasping the finished bouquet (only a few flowers are illustrated for clarity), which is ready to be bound together at the stems.

In alternate embodiments, instead of resting the rods 14 on a lower surface and moving the jig 10 down to facilitate bouquet removal from the jig 10, electrical or pneumatic means may be implemented to force the rods 14 through the tubes 12 as pistons through their cylinders.

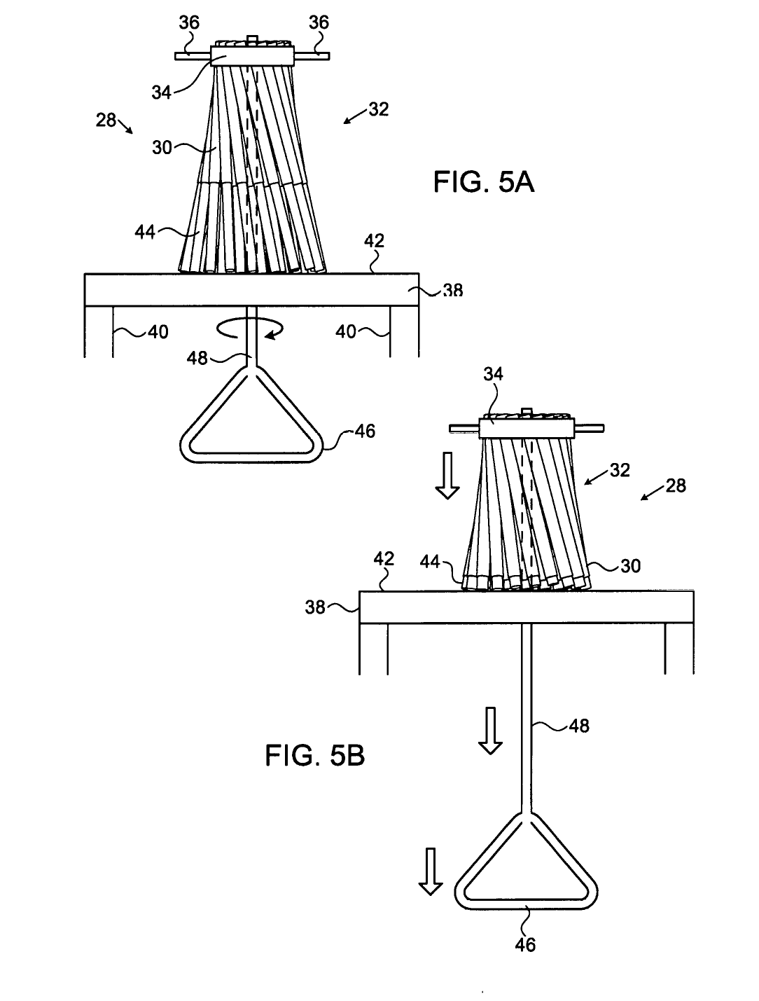

A jig assembly 28 of another embodiment of the invention is described with reference to FIGS. 5A and 5B. In this embodiment, multiple tubes 30 of a jig 32 are coupled near the tops of the tubes 30 by a disk 34 oriented normal to the common vertical, that is, to the axis of radial symmetry of the jig 32. Two handles 36 extend from the disk 34 of the jig 32 such that rotational movement of a handle 36 causes rotation of the jig 32. Accordingly, a user may conveniently rotate the jig by rotating a handle 36 about the common vertical of the tubes 30 while inserting flowers/foliage elements into the tubes 30 to arrange a bouquet. The jig assembly 28 includes a rod support plate 38 held up by legs 40 as a table top is held up by table legs. The rod support plate 38 has an upper surface 42 that contacts the bottoms of multiple rods 44, which are at least partially contained within the tubes 30 as discussed above.

The jig assembly 28 also includes a pedal 46 that is coupled to the disk 34 of the jig 32 by a shaft 48. The pedal 46 is suitable for the user to engage with his/her foot to effect vertical movement of the pedal 46. A spring (not shown in drawings for clarity) biases the jig 32, shaft 48, and pedal 46 upward, and accordingly the user may force the pedal 46 downward with his/her foot against the spring biasing force to cause the jig 32 to descend toward the upper surface 42 of the rod support plate 38 and thereby causing the tubes 30 to surround more of the rods 44. FIG. 5A illustrates the jig 32 in its upper position, and FIG. 5B illustrates the jig 32 in its lower position. When the jig 32 is forced downward, as shown in FIG. 5B, the upper surfaces of the rods 44 contact the lower surfaces of the stems of the flowers/foliage elements within the tubes 30 to force them upwardly and out of the tubes 30 when the user want to extract the bouquet.

Variations of the preceding embodiment are within the scope of the invention. For example, although the pedal 46 of the embodiment rotates with the rotation of the handles 36, the disk 34 may be modified to rotate relative to the shaft 48 and the pedal 46 to enable convenient user access to all tubes 30 while the pedal 46 remains oriented optimally toward the user for engagement with the user's foot.

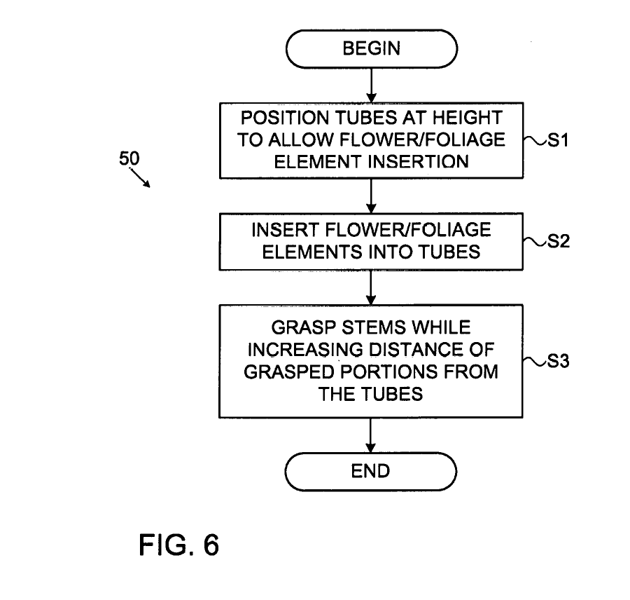

The present invention also may be embodied as a process of using a jig assembly to arrange a bouquet. Such embodiment will be described with reference to the flow chart 50 in FIG. 6. The jig assembly in this embodiment has multiple tubes oriented skew to each other and multiple rods inserted into the tubes. Example jig assemblies suitable for this process are illustrated in FIGS. 4B (jig assembly 16) and 5A (jig assembly 28).

The method begins by positioning the tubes at a height so that the rods extend out of the tubes far enough to allow insertion of flower/foliage elements deep enough into the tubes so that the flower/foliage elements remain in place. (Step S1.) FIGS. 4B and 5B illustrate such positioning. As is apparent, a jig assembly further includes a jig stand that maintains its jig at a particular height.

The next step is to insert flower/foliage elements into the tubes. (Step S2.) FIG. 4C illustrates tubes with flower inserted therein. The tubes of the embodiment of FIG. 5A can be rotated for convenient flower/foliage elements insertion by moving the handles at the top of the jig assembly.

Next, the user grasps the stems of the flower/foliage elements while simultaneously increasing the distance between the grasped portions of the stems and the tubes such that the force of the top faces of the rods against the bottoms of the stems increases. (Step S3) Eventually, the distance is increased enough to enable easy removal of the flower/foliage elements from the jig. FIG. 4D shows that the user lowers the sliding jig clamp to lower the tubes. FIG. 5B shows that the user may lower a foot pedal to lower the tubes. Alternatively, the user may push the handles 36 or disk 34 to lower the tubes. In both examples, the distance between the grasped portions of the stems and the tubes is increased by moving the tubes downward.

Having thus described exemplary embodiments of the invention, it will be apparent that various alterations, modifications, and improvements will readily occur to those skilled in the art. Alternations, modifications, and improvements of the disclosed invention, although not expressly described above, are nonetheless intended and implied to be within spirit and scope of the invention. Accordingly, the foregoing discussion is intended to be illustrative only; the invention is limited and defined only by the following claims and equivalents thereto.

I claim:

1. A jig for arranging flowers, the jig comprising:
a set of multiple tubes;
wherein each of the multiple tubes is oriented skew to the other tubes.

2. The jig of claim 1 further comprising:
an additional tube that is collinear with a common vertical.

3. The jig of claim 1, wherein each of the multiple tubes are oriented at roughly the same angle to a common vertical.

4. A jig assembly for arranging flowers, the jig assembly comprising:
the jig of claim 1; and
multiple rods having diameters less than the inner diameters of the tubes of the jig.

5. The jig assembly of claim 4 further comprising:
a jig stand vertically-movably holding the jig.

6. The jig assembly of claim 4 further comprising:
a surface contacting the bottoms of the multiple rods; and
a pedal coupled to the jig;
wherein forcing the pedal downward causes the jig to descend and the tubes to surround more of the rods.

7. The jig assembly of claim 6 further comprising:
at least one handle extending from the jig;
wherein movement of the at least one handle causes rotation of the jig;

8. A process of using a jig assembly to arrange a bouquet, the jig assembly including multiple tubes oriented skew to each other and multiple rods inserted into the tubes, the process comprising:
positioning the tubes at a height so that the rods extend out of the tubes far enough to allow insertion of flower/foliage elements deep enough into the tubes to remain in place;
inserting flower/foliage elements into the tubes; and
grasping the stems of the flower/foliage elements while increasing the distance between the grasped portions of the stems and the tubes such that the force of the top faces of the rods against the bottoms of the stems increases;
wherein said distance is increased enough to remove the flower/foliage elements entirely from the jig.

9. A process of claim 8, wherein the jig assembly further includes a jig stand that maintains the tubes at a particular height.

10. A process of claim 8, wherein the distance between the grasped portions of the stems and the tubes is increased by moving the tubes downward.
